(19) United States
(12) Patent Application Publication
(10) Pub. No.: US 2004/0165477 A1
(43) Pub. Date: Aug. 26, 2004

(54) Radial continuous coupled magnetic mixing device

(75) Inventor: Terry D. Long, Tucson, AZ (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Argonaut Technologies, Inc., Foster City, CA

(21) Appl. No.: 10/781,407

(22) Filed: Feb. 18, 2004

Related U.S. Application Data
(60) Provisional application No. 60/448,151, filed on Feb. 18, 2003.

(51) Int. Cl. B01F 13/08

(52) U.S. Cl. 366/273

(57) ABSTRACT

A mixing apparatus comprises a plurality of reactors/reaction vessels controlled by a single graphical user interface. Each of the reactor modules is independent and may be used as such. A magnetic impeller is located inside each reaction vessel, the impeller having a magnet integrated into the profile. External magnets are located radially outside of the wall of each reaction vessel. Rotational motion is provided to these external magnets thereby inducing the internal magnetic impellers to rotate and induce mixing/agitation to the reaction vessel contents. The usage of strong external magnets enables strong magnetic coupling to the internal impeller enabling mixing of normally difficult to mix contents. The ability to adjust the vertical location of the external magnets further enhances functional ability enabling optimized location of the internal magnet for the specific volume/vessel content mixtures combinations.

### CROSS-REFERENCE TO RELATED APPLICATIONS

This application claims the benefit of provisional patent application No. 60/448,151, filed Feb. 18, 2003.

### BACKGROUND

The present invention is related to the field of laboratory instrumentation, and particularly to the field of magnetic mixers used in association with laboratory reactors.

There are many commercial and custom reaction block systems in existence, but none to date provide the required features to perform difficult and demanding synthetic reactions routinely. One shortfall of existing systems is that the mixing systems are not robust and cannot be used in biphasic or highly viscous solutions. In particular, many prior art systems experience loss of magnetic agitator/impeller coupling during agitation. This loss can occur due to speed, viscosity, solids or other objects influencing/exceeding the coupling strength of the agitator/impeller system. Furthermore, prior art systems experience difficulty with volume mixing efficiency. In particular, agitation efficiency in vessels during chemical processing is commonly changed as volume and contents varies. Current systems do not enable easy optimization and adjustment during operations. In addition, access to reaction vessels during operations for additions, sampling and insertion of analytical probes is often a problem, as direct driven shaft impeller technology impedes access to vessel tops.

As mentioned above, one significant issue with existing laboratory mixers and small scale, reaction block systems is the lack of high magnetic coupling strength. Typically, in these systems, the magnetic stirrer inside the reactor decouples from the external drive magnets and vessel mixing losses occur, which negatively affects the outcome of the experiment. These losses typically occur when a highly viscous solution forms, after addition of solids into the reactor, upon formation of precipitates during reaction and when the mixing speed is increased to achieve the functional stirring of reactor contents. The detachment of the coupling is a common occurrence in these systems and is normally attributed to insufficient magnetic coupling strength. Negative influences that contribute to loss of magnetic coupling include the following:

Lack of continuous magnetic coupling—Electromagnetic technology and some multiple vessel single drive magnet technologies never establish direct coupling to the internal magnet. These technologies typically utilize a short term interaction then decoupling followed by subsequent short term interaction again thereby sacrificing strength and reliability.

Poor alignment of magnetic fields—Many mixing technologies don't align the magnetic field lines for maximum interaction, either the drive or internal magnet is skewed from optimal interaction alignment.

Excessive coupling distance—The distance between drive and internal magnet may be less than optimal to meet mechanical or thermal design requirements of the systems.

Magnet located on vessel bottom—Frequently, reactor contents contain solids or high density materials that accumulate at the bottom of the containment vessel. Typical laboratory magnetic mixers utilize magnetic attraction oriented through the vessel bottom, thereby locating the magnet at the vessel bottom. This location can cause frictional resistance due to the coupling energy forcing the internal magnet into the vessel bottom. More importantly, the magnet being located at the bottom positions it within the high solids or dense material region. This can prevent the magnet from initiating movement due to excessive shear forces and momentum influences. Another potential negative aspect is the case of fragile materials in the vessel such as catalysts or biological materials (cells, etc). The bottom located magnet impacting the vessel bottom can damage the materials due to direct impact and high shear forces.

Another issue with many existing magnetic mixing systems is the fixed position of the internal magnet. With a fixed position magnet, the external magnet is typically located directly beneath the reaction vessel, which as previously stated, positions the reactor magnet at the bottom of the vessel. In order to effectively mix the upper portion of a volume of the reactor contents, the mixing speed must be extremely high to induce motion at the vessel top. The inefficiencies are even more exaggerated in mixtures with immiscible fluids (i.e., biphasic solutions), heterogeneous mixtures (i.e., liquid/solid mixtures, especially solids that float on the fluid surface) and with high aspect ratio vessels (i.e. having length to diameter ratios greater than 2.0). The latter occurrence is most common as synthetic protocols are often conducted in serial chemical operations which incrementally add volume to the vessel, (e.g., a first step is to add 2 ml of one reagent and a subsequent step is to add enough reagent to complete a 10 ml reaction). Therefore, it would be extremely beneficial to have a mixing system in which the internal magnet position could be vertically adjusted for the specific mixture requirements at specific operational conditions, which is how the radial continuous coupled magnet system operates.

As discussed previously, a common problem in conducting chemical processing in small volume reactors is ergonomic access to the reactor. As these reactions are typically conducted between 1 to 500 mls, the reactors themselves typically have small diameters. If direct drive (shaft driven) impellers are utilized for agitation, the shaft and associated seals and bearings occupy substantial space in the reactor top, thereby limiting access. Access is desirable for addition and removal of materials as well as for interface to commonly used chemistry tools such as pipette tips and glassware (condensers, distillation columns, addition funnels, etc). Good access is also desirable to enable utilization/insertion of analytical probes and technologies for insitu monitoring of the reactions.

A common mechanism of mixing reactors with highly viscous contents, biphasic contents and solutions containing solids is to utilize a shaft driven impeller with a motor. The use of direct-drive technology is typically associated with larger vessels, which require high-energy to efficiently mix these larger volumes. During chemical process screening and optimization, it is desirable to mimic the mixing characteristics of the technology that will be used for larger volumes. However, the current lower volume reactors do not typically utilize the direct-drive approach. As for small volume reactions direct-drive technology is costly, occupies substantial space and impedes access to the reactors for additions and sampling. For these and other reasons, most small volume reactions utilize bottom magnetic stirring technologies. The lack of similarity of technologies severely limits the scaling value of smaller volume testing data for process and scale-up related applications.

### SUMMARY

A laboratory mixing device comprises a plurality of reactors positioned within a single module. A plurality of wheels are provide with each wheel encompassing one of the reactors such that the axis of the wheel is substantially coaxial with the at least one reactor. The wheels are rotatable about the reactors and may also be moved vertically with respect to the reactors. Two drive magnets are positioned upon each wheel. The two drive magnets comprise permanent magnets that provide opposite magnetic poles upon the wheel. An impeller/mixer is positioned within each of the reactors. The impeller/mixer comprises a permanent magnet having opposing poles. One pole of the mixer is magnetically attracted to one of the permanent magnets on the wheel while the opposite pole is magnetically attracted to the other permanent magnet upon the wheel. The magnetic coupling between the drive magnets and the mixer magnet results in rotation of the mixer when the drive magnets rotate.

The wheels that hold the drive magnets may be rotated about the reactor axis by any of several means. For example, in one embodiment, the wheels are rotated by a pulley that is driven by an electric motor. In another embodiment, the wheels are rotated by a gear mechanism that is driven by an electric motor.

A lift is provided for moving the wheels parallel to the reactor axis. The lift includes a mixer case that supports all of the wheels. Movement of the mixer case with respect to the reactors thereby results in movement of each of the wheels with to the reactors. Vertical movement of the wheels results in vertical movement of the mixers within the reactors. The lift may be incorporated by any number of means. For example, in one embodiment the lift is incorporated by a handle that turns a crankshaft. The crankshaft, in turn, rotates a worm gear that moves a push rod up and down. The push rod is connected to the mixer case, thereby resulting in up and down movement of the wheels and magnets.

### BRIEF DESCRIPTION OF THE DRAWINGS

FIG. 1 is a front perspective view of a module of a Radial Continuous Coupled Magnetic Mixing Device and System;

FIG. 2 is a side perspective view of the module of FIG. 1;

FIG. 3 is a cross-sectional of the module taken along line A-A of FIG. 2;

FIG. 4 is a top perspective view of a the top of a reactor in the module with the removable top partially invisible;

FIG. 5 is a sectional view of the module reactors with the reactor holder and base removed;

FIG. 6 is an schematic of the cooling fluid flow operation of the System of FIG. 1;

FIG. 7 is a sectional partial rear view of the mixer case shown in FIG. 1;

FIG. 8 is an enlarged view of a rotating magnetic drive;

FIG. 9 is a cross-section of the rotating magnetic drive of FIG. 8;

FIG. 10A is a diagram showing representative drive magnets and their associated stir bars in the reactors of the reactor modules;

FIG. 10B schematically depicts the magnetic field resulting between a pair of drive magnets and an associated stir bar within a reactor;

FIG. 11 is a schematic of an inert gas system for use with the module of FIG. 1;

FIG. 12 is an alternative embodiment showing two mixer cases included on one module; and

FIG. 13 is an alternative embodiment showing a motor that drives the rotating magnetic drives through a worm gear.

### DESCRIPTION

System Overview

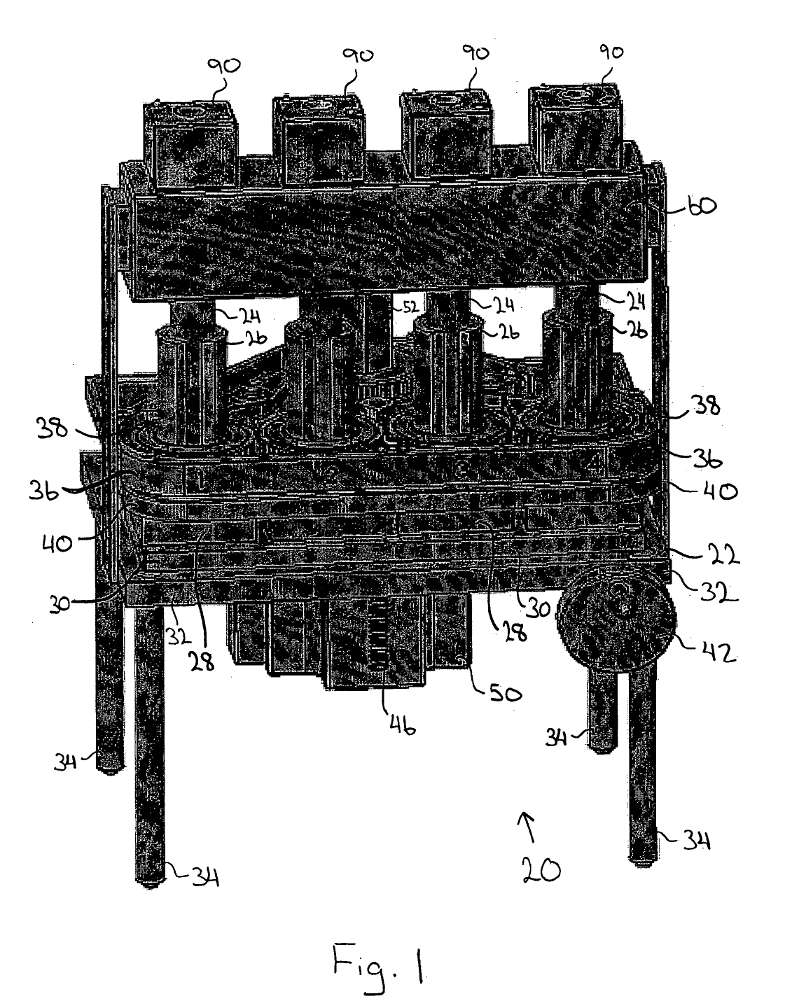

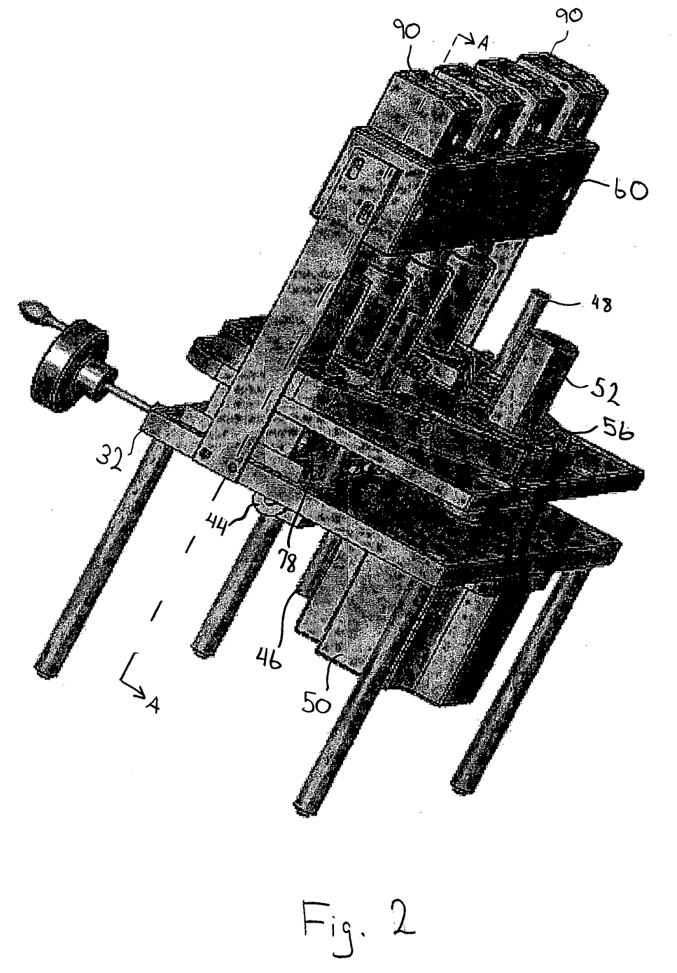

With respect to FIGS. 1-4, a Radial Continuous Coupled Magnetic Mixing Device and System 20 comprises a plurality of identical modules (or reactor blocks) 22 and each module 22 contains four small parallel reactors 24. Each reactor 24 is typically a standard size test tube (e.g., 20 millimeters diameter×150 millimeters long) and has a design working reaction volume of 2 to 10 milliliters. Each reactor defines a central axis 84 and is cylindrical in shape with a circular cross-section, but the reactors may take on any number of different shapes. The system may be controlled through a single user interface (e.g., a graphical user interface) that may be incorporated as part of the module or as part of a remote or local computer that is connected to the module. FIGS. 1 and 2 show front and side perspective views of a single module stripped of its outer metallic shell (or skin), graphical user interface, piping, and wiring, etc. The system is designed to fit inside a conventional fume hood. To this end, one to three modules may be used under a conventional fume hood, with each of the modules measuring approximately 10 inches wide, 12 inches deep, and 12 to 14 inches high. The system 20 provides a modular laboratory-scale reactor system for conducting routine organic chemistry screening reactions. In one embodiment, the device is operable to provide accurate temperature monitoring and control, reliable mixing of biphasic and highly viscous reaction mixtures, inert reaction environment, reflux capability, and visibility of the reaction mixture during reaction in each reactor 24.

Overview of Module Structure

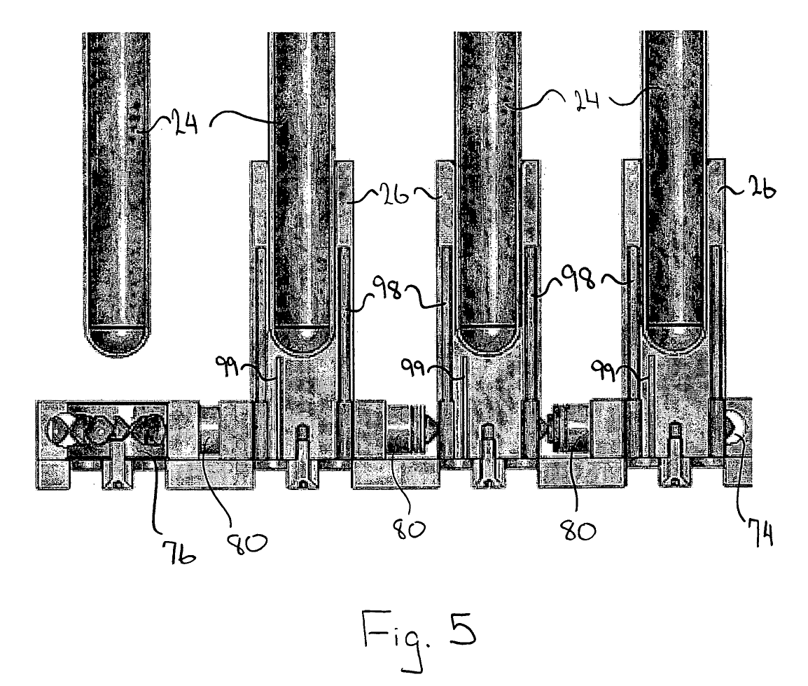

As shown in FIGS. 1 and 2, each module 22 includes four test tube reactors 24, each reactor including a magnetic stir bar (not shown) positioned therein. Each reactor 24 is held by its own reactor holder 26 with each holder sitting on its own base 28. As shown in FIGS. 1 and 5, the upper portion of the reactor holder 26 is split and consists of at least one C-shaped portion that forms a vertical gap, which allows the bench chemist to observe the reaction. Backlighting (not shown) may be provided if desired. The four bases 28 rest on a common base mount 30, which in turn sits on the lift base 32. Four legs 34 support the lift base 32.

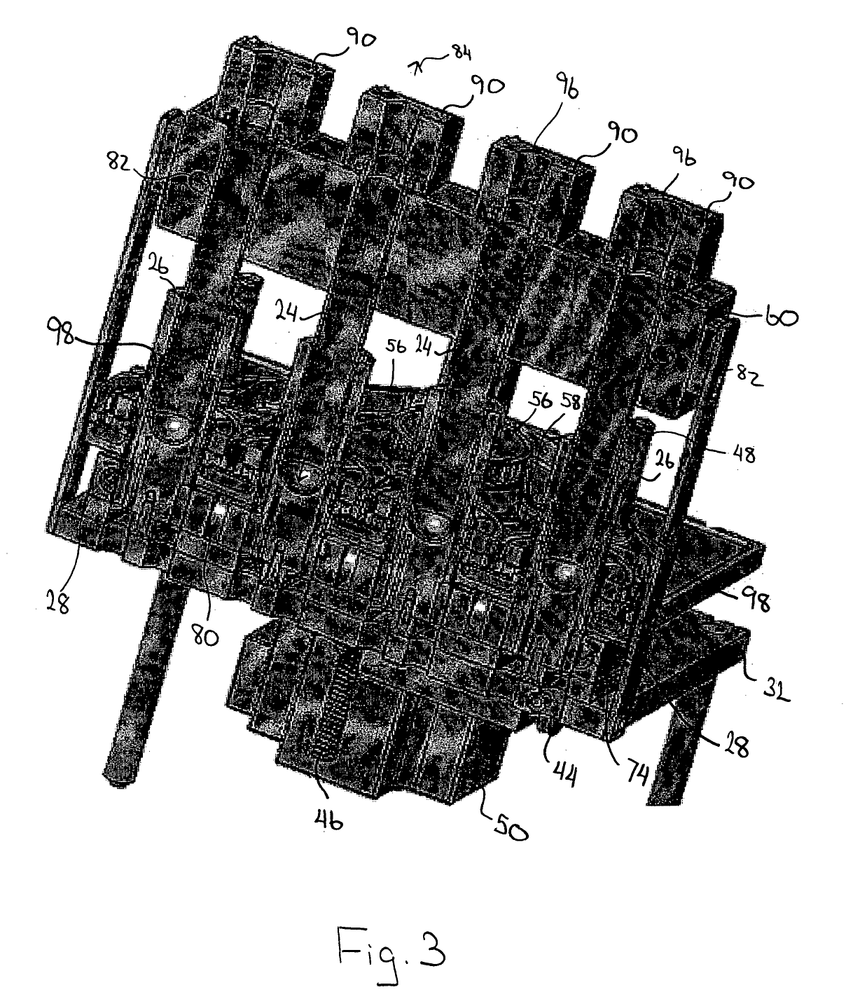

A mixer case 36 is positioned about the reactor holders 26, above the holder bases. The mixer case 36 contains four rotating magnetic drives 38 and related drive mechanisms (explained in more detail below) used to rotate the magnetic drives. Rotation of the magnetic drives 38 cause the magnetic stir bars inside each reactor 24 to rotate and thereby stir reaction mixtures within the reactors. The mixer case 36 can be moved up and down, thereby moving the four magnetic drives up and down (i.e., longitudinally or vertically) outside the reactors 24 and, in turn, moving the four stir bars up and down within the reactors. The mixer case 36 sits atop a drip tray 40 that is positioned above the holder bases 28. Rotating the lift handle 42 causes a worm gear 44 mounted on the bottom face of the lift base 32 (best seen in FIG. 2 and sectional FIG. 3) to rotate. The worm gear 44 is operably connected to a push rod 46. Rotation of the worm gear 44 drives the push rod 46 up or down. The push rod 46 is connected to the drip tray 40 and mixer case 36. Therefore, up or down movement of the pushrod respectively raises or lowers the drip tray and mixer case together. The mixer case 36 and drip tray 40 both ride upon two stationary guide posts 48 which assist in maintaining the proper lateral position of the drip tray and mixer case as they are moved up and down. Accordingly, a lift is provided that is operable to move the magnetic drives 38 up and down with respect to the reactors 24 when the mixer case 36 is moved up and down. The up and down movement of the individual magnetic drives 38 is accomplished coaxial with the central axis 84 of the associated reactor.

A motor 50 is also mounted underneath the lift base 32. The motor 50 rotates a drive shaft 52. A drive pulley 56 is coaxial with and slideably connected to the drive shaft 52. A drive belt 58 encompasses the drive pulley 56 and four magnetic drives 38. As explained in more detail below, rotation of the drive shaft 52 rotates the drive pulley 56, which moves the drive belt 58 and causes the four rotating magnetic drives to rotate, thereby rotating the magnetic stir bars inside the reactors. As described below, cooling fluid flowing through the four bases 28 (underneath the reactors 24) and the cooling manifold 60 (at the tops of the reactors), along with electric heaters in the four bases, provide cooling and heating for the reaction mixtures.

Temperature Control and Reflux

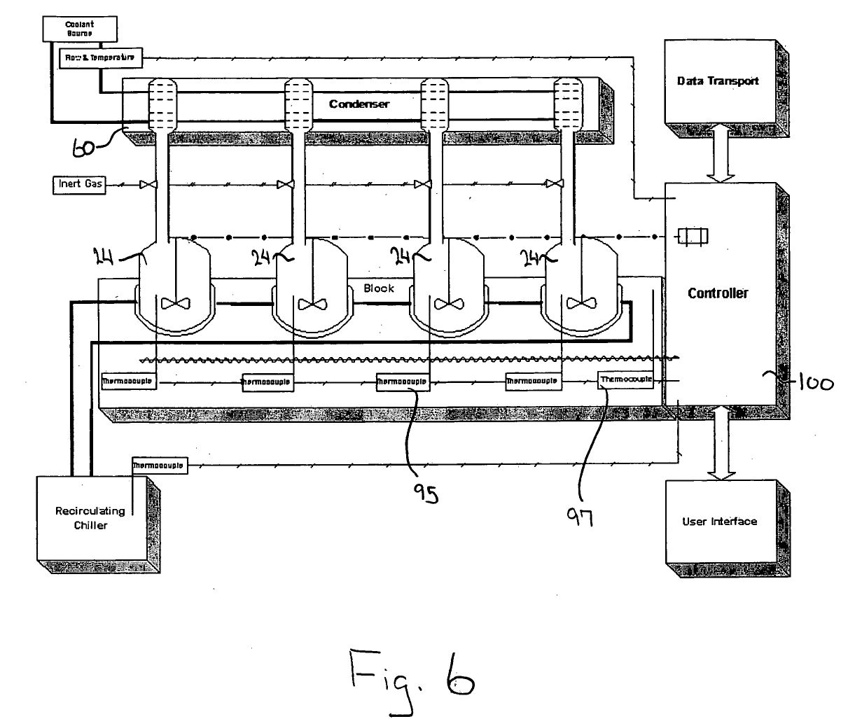

With reference to FIGS. 3, 5, and 6, each of the four bases 28 is made of a highly thermoconductive material (preferably copper) and has a passageway 74 for cooling fluid flow (e.g., silicone cooling fluid, ethylene glycol solution). Each passageway 74 contains a static (helical) mixer 76 (see FIG. 5) to improve heat transfer. The passageways 74 of the four bases are connected in series (see FIG. 6), with an inlet port/outlet port 78 to the series at the back of bases 1 and 4 (see FIG. 2). Three gasketed cross tubes 80 connect the four bases (see FIG. 3 and FIG. 5). The cross tubes are of non-thermoconductive material (e.g., TEFLON) to thermally isolate the four bases from each other to allow independent and accurate temperature control of each base. Cooling fluid flowing from a recirculating chiller (see FIG. 6) enters the series of bases through the inlet port 78 (at the back of a reactor base), flows from base to base through the cross tubes 80, and exits the series through the outlet port 78 (at another reactor base).

Volatiles (e.g., solvent) in the vapor phase in the reactors are cooled and condensed by the cooling manifold 60 (preferably of aluminum), through which cooling fluid flows (see FIG. 3 and FIG. 6). The cooling manifold 60 has cooling fluid inlet/outlet ports 82 and a plurality of cooling fluid passageways (not shown) that snugly surround the top portion of a different one of the four reactors. A static (helical) mixer 76 is located in the cooling fluid passageway to improve heat transfer. Liquid condensate from the reactor refluxes (returns) to the reaction mixture by flowing back down the wall of the reactor to the liquid reaction volume.

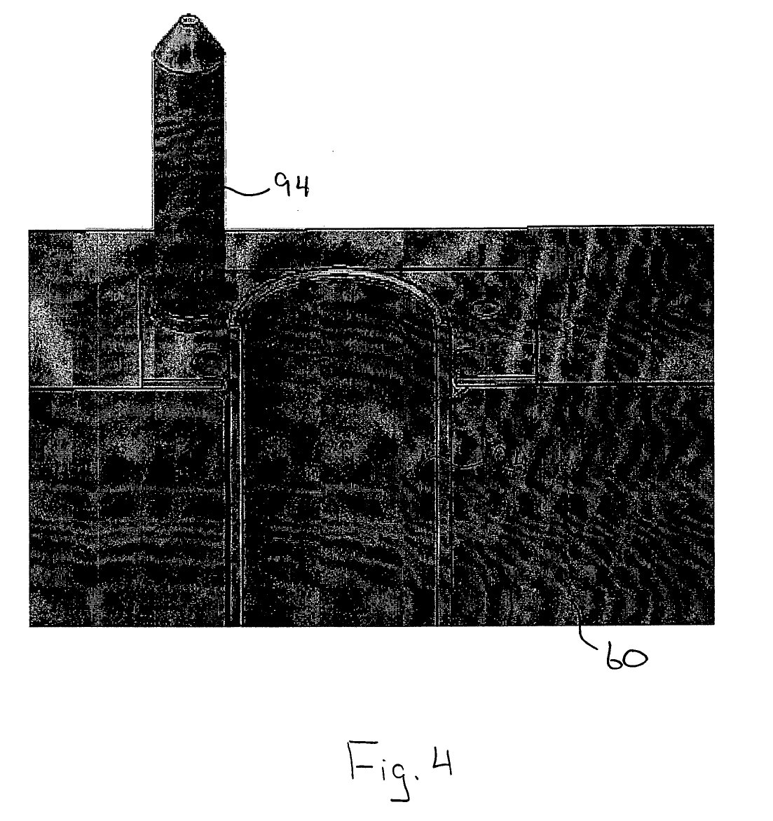

A removable top (also referred to herein as a sealing block) 90 is positioned at the top of each reactor, above the cooling manifold 60. The removable tops 90 are of inert material (preferably TEFLON) and each is cooled by a copper cooling pin that extends vertically from the cooling manifold 60 into a channel the removable top 90 (see FIG. 4). Each removable top 90 has one or more septa and/or passageways 96 leading to the top of the associated reactor 24 (see FIG. 3), which can be used to add or withdraw material from the reactor before, during, or after reaction. The upper end of each reactor 24 is held snugly enough within its removable top (sealing block) 90 by a compression O-ring 92 so that removal of the top by pulling it upward also pulls the reactor up. Thus, each reactor is removed from the module 22 by pulling the respective removable top (sealing block) 90 up sufficiently for the bottom of the reactor to clear the top surface of the cooling manifold 60.

Each reactor holder 26 is made of a highly thermoconductive material (preferably copper) and is in intimate contact with its respective base 28 to facilitate good heat transfer. The longitudinal concavity of each holder 26 is sized to snugly hold its reactor 24 to facilitate good heat transfer. The top edge of the split upper portion of each holder extends just above the normal topmost liquid level in each reactor. Heat is provided to each reactor holder 26 by electrical heating elements (not shown), which are placed in vertical channels 98 in the reactor holder (see FIG. 3 and FIG. 5). As noted in FIG. 6, a thermocouple 95 (see FIG. 6) is placed in a vertical bore 99 in each reactor holder (see FIG. 3 and FIG. 5) for temperature sensing. Another thermocouple 97 (shown in FIG. 6) extends into the reaction mixture. Information from the two thermocouples for each reactor is provided to a controller 100 and used to monitor and/or control the cooling fluid flow (to the bases and/or cooling manifold) and/or electrical flow (to the heaters).

The temperature of the reactors may be maintained within the range of about −25° C. to 110°. Thermal isolation of the reactor holders is good enough to allow their temperatures to be maintained concurrently at 30° C. (reactor 1); 110° C. (reactor 2); 30° C. (reactor 3); and 110° C. (reactor 4), for example. As another example reactor temperatures may be maintained concurrently at 5° C. (reactor 1); −5° C. (reactor 2); 15° C. (reactor 3); and 35° C. (reactor 4). The amount of cooling provided by the four bases and/or the cooling manifold and the amount of heating provided by the heaters depends on the temperature at which each reactor is to be run and on the degree of endothermicity/exothermicity of each reaction mixture. If all reactors are to be operated at sub-ambient temperature, cooling fluid is circulated through the four bases and/or the cooling manifold. The heating elements in each reactor holder are then used to provide precise control by acting as trim heaters. If the reactor temperatures are to be above ambient, the heaters may be used, with or without cooling fluid flow in the cooling manifold (to provide influx) and the four bases. Control of the heaters is by slope correction algorithm and control of the cooling fluid flow is by proportional integrated control.

Radial Continuous Coupled Magnetic Mixing

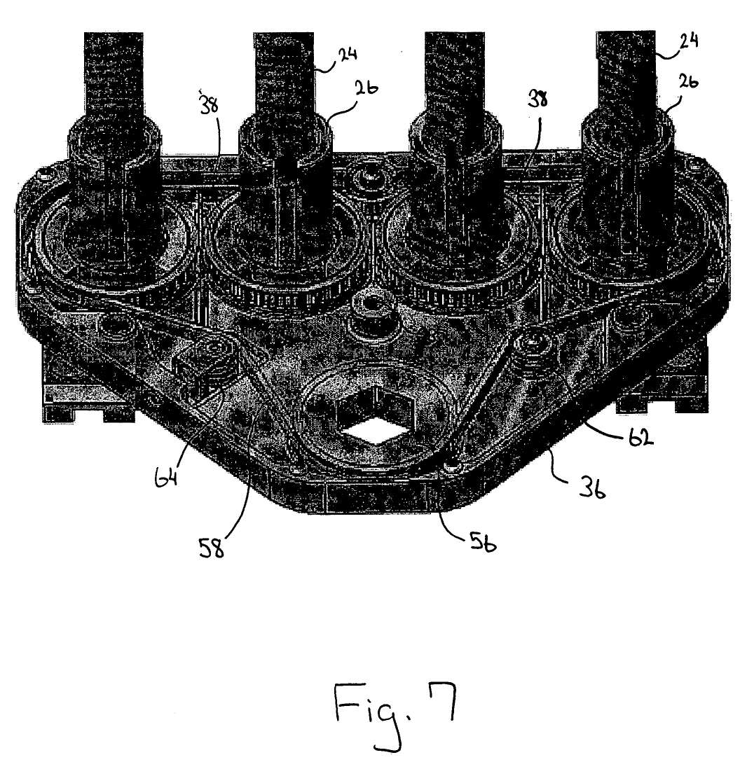

As described above, the mixer case 36 is positioned above the drip tray 40 and the two are moved up and down by rotating the lift handle 42, which rotates the worm gear 44 to move the push rod 46 up and down. The top of the push rod 46 abuts and is secured to the mixer case 36. The upper outer surface of the mixer 36 case is shown in FIG. 7, which shows a center hole 37 which acts as the pushrod receiver. The center hole allows a portion of a screw to pass there-through and attach the pushrod to the mixer case 37. Because the pushrod is connected to the mixer case 36, upward and downward movement of the pushrod also moves the mixer case up and down.

The hexagonal drive shaft 52 extends through a hexagonal opening in the drive pulley such that rotation of the drive shaft 52 causes rotation of the drive pulley. However, the drive pulley is allowed to float vertically up and down the drive shaft when the mixer case is adjusted upward or downward. The drive shaft is rotated by the motor 50, thereby rotating the drive pulley 56, which causes the timing (drive) belt 58 to rotate upon its track and drive the four driven pulleys. A guide pulley 62 and a tensioner 64 are also provided on the track of the drive belt 58. The guide pulley 62 and tensioner 64 assist to keep the drive belt 58 on track and in sufficient frictional contact with the four magnetic drives 38 to impart rotation to the magnetic drives 38.

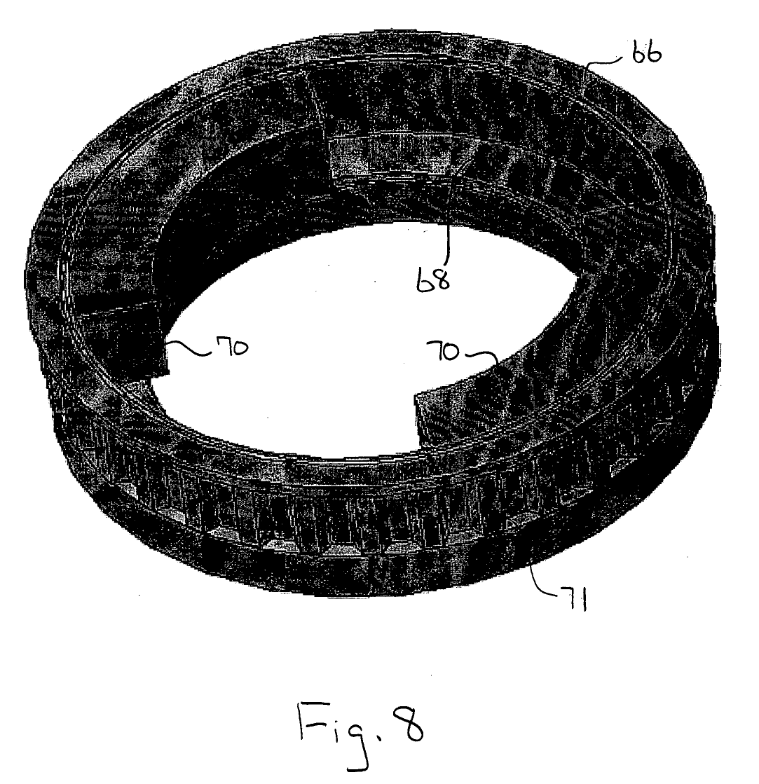

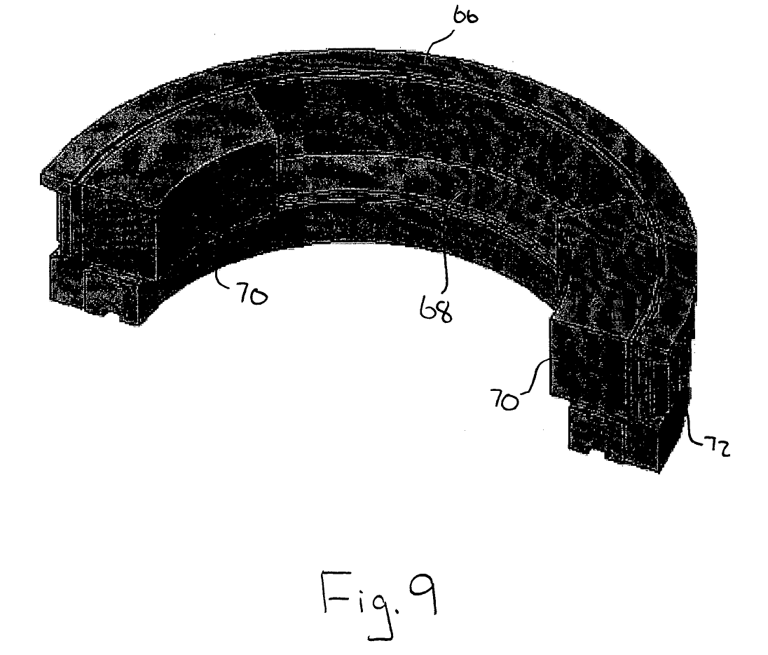

Each magnetic drive 38 acts as a driven pulley when driven by the belt 58. As shown in FIGS. 8 and 9, each magnetic drive 38 comprises a cylindrical portion 66 and a planar horizontal shelf 68, which is located slightly below the middle of the cylindrical portion and extends around the entire inner surface of the cylindrical portion. Two oppositely disposed arcuate drive magnets 70 rest on and are fastened to the shelf 68 so that the two magnets rotate as part of the driven pulley. The drive magnets 70 are strong permanent magnets (preferably rare earth magnets of neodymium-iron boron, e.g., Neodymium 38H, which are mechanically strong but corrode and are not usually employed at temperatures above 80° C.). Each magnet occupies about one-quarter (e.g., 90°) of the circumference of the cylindrical portion and the drive magnets are directly opposed upon the horizontal shelf 68. Each magnet has a rectangular cross-section. In a preferred embodiment, the inside radius of each arcuate magnet is 0.685 inches, the outside radius is 0.953 inches, the width is 0.268 inches, and the height is 0.347 inches. One drive magnet has its north pole at its inner arcuate surface and the outer drive magnet has its north pole along its outer arcuate surface. The cylindrical portion 66 forms the housing for the magnetic drive and includes a toothed outer circumference 71. The shape and material of the housing (400 series stainless steel) shields drive magnets in adjacent magnetic drive assemblies from each other.

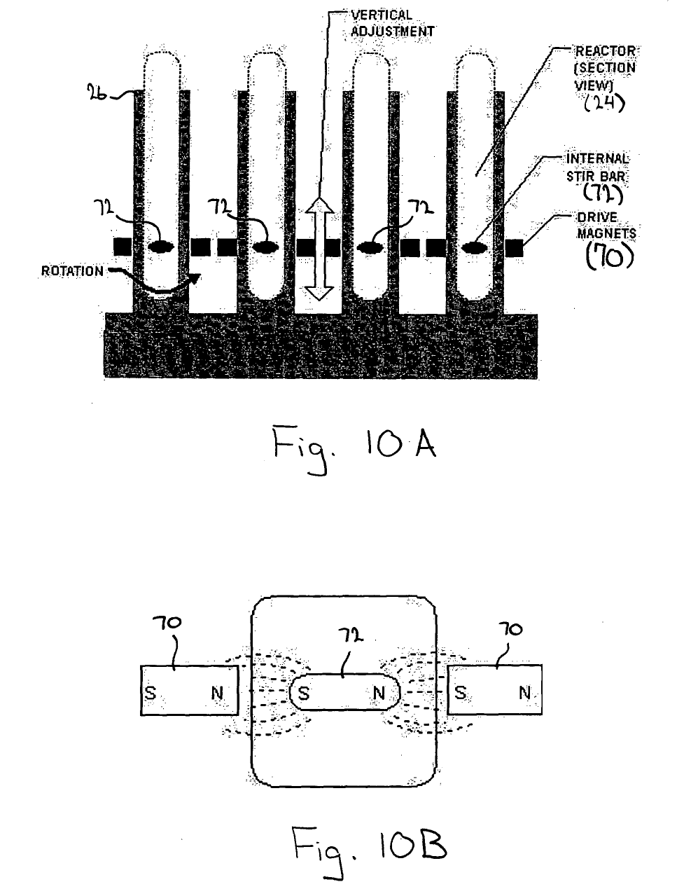

As indicated in FIG. 10A, a mixer in the form of a stir bar 72 is positioned inside each reactor. Each stir bar is a strong permanent magnet (preferably a rare earth magnet of samarium cobalt, i.e., SmCo, which is stable under high temperature and resists corrosion but is mechanically weak and brittle). The two drive magnets 70 (the two arcuate magnets in the magnetic drive 38 outside each reactor) and corresponding driven magnet 72 (the stir bar inside the corresponding reactor) are strong magnets and are located in close proximity. In particular, a distance of only a few millimeters made up of the width of the exterior reactor wall 24 and the exterior reactor holder 26 separates each pole of the stir bar 72 from its opposite pole on the arcuate drive magnets. Accordingly, the magnetic coupling between the drive magnets and the stir bar is very strong. FIG. 10B schematically depicts a pair of drive magnets 70, their respective stir bar 72, and the resulting magnetic fields between them. The magnetic coupling is also essentially constant (i.e., the coupling does not change during rotation). This constant magnetic coupling is in contrast to conventional electromagnetic drive systems, where the magnetic coupling is not constant. For example, in electromagnetic drive systems, the momentary pulsing of electromagnetic coils momentarily decreases or removes the field between the electromagnet and the stir bar, thereby greatly weakening the coupling.

In the disclosed embodiment of the system, rotation of the driven pulleys and the constant strong coupling between each set of drive and driven magnets rotates the driven magnets (stir bars) even when the viscosity of the reaction mixtures reaches 10,000 centipoises (roughly the viscosity of honey at room temperature with about 16% water content) at speeds of rotation of from 200 to 2000 rpm. Furthermore, because of the constant strong magnetic coupling, the stir bar inside each reactor is moved up and down in synchronization with the upward and downward movement of the mixer case (which is moved up and down by rotating the lift handle). The maximum upward travel of the mixer case is to a height near the top of the split upper portion of the reactor holder, which is also about the maximum height of liquid in the reactor during operation. Therefore, the stir bars can be moved up to roughly the highest normal level of the reaction mixture.

Inert Environment

All surfaces that are expected to contact the reactants and/or products tested using the system 20 are inert. The reactors 24 are of borosilicate glass (quartz could be used but is substantially more expensive), the removable tops (sealing blocks) 90 are of TEFLON, and the tubing, O-rings, and outside of the stir bars are of TEFLON, polyethylene, or polypropylene. The liquid and solid reactants and catalysts may be charged to the reactor under an inert environment (e.g., under a nitrogen or argon pad) and then the removable top (sealing block) 90 pushed onto the top of the reactor (the top of the reactor passing through the tightly fitting O-ring), thereby isolating the contents of the reactor from the environment (as some of the reactants and catalysts may be oxygen- and/or moisture-sensitive). The reactor may then be pushed down through the bore for the reactor 24 in the cooling manifold 60 until the bottom of the reactor contacts the bottom of the concavity formed by the two split upper halves of the reactor holder 26. As the reactor is pushed down and before it reaches the bottom of its travel into the reactor holder, the copper cooling pin extending upward from the top of the cooling manifold mates with the corresponding bore in the removable top (sealing block) 90 (see FIGS. 3 and 4). If the contents of the reactor 24 do not need to be isolated from the environment while being charged, the contents may be placed in the reactor, the reactor may be put in place, and then the removable top (sealing block) put in position.

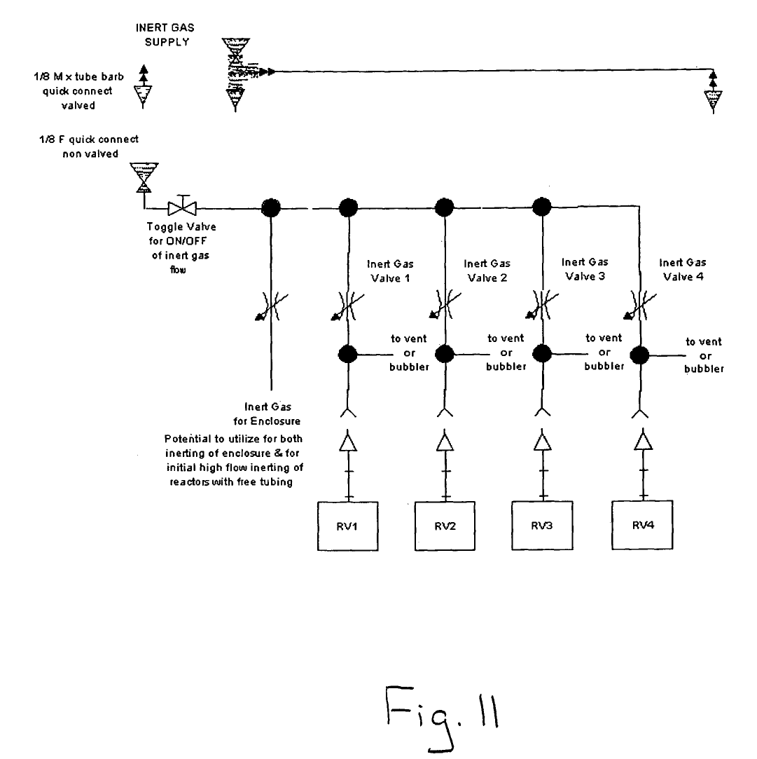

An inert gas system allows for sweeping the reactor headspace with inert gas and providing an inert gas pad during the reaction (see FIG. 11). After a reactor has been put in place (either by putting it in place with the top on it or putting it in place and then positioning the top), the inert gas valve for that reactor is opened. That allows inert gas to flow through the supply tubing into the reactor and maintain a positive pressure inert gas pad on the contents of each reactor. The velocity of the inert gas into the reactor and Brownian motion mix the gases and sweep the reactor head space, thereby cleaning out the gas (e.g., air) that was present. Gas leaving the system flows out through a vent or a bubbler.

### EXAMPLE ALTERNATIVE EMBODIMENTS

As described above, the Radial Continuous Coupled Magnetic Mixing Device facilitates early-stage, small scale, organic reaction screening by providing efficient reaction control operations. In one embodiment, these operations include variable speed mixing to 2000 rpm, variable impellor height adjustment, high strength magnetic radial mixing, a relatively low cost; and high viscosity and biphasic mixing capability. However, while the present invention has been described in considerable detail with reference to certain preferred versions thereof, other versions are possible. For example, in an alternative embodiment of the invention, the ability to automatically move the vertical location of the mixing system could be added. One embodiment would be to allow the operator to specify the desired upper and lower vertical reactor position limits as well as the linear sweep rate or cycle frequency. A controller, motor and associated hardware would then controllably drive the magnet mixing system vertically up and down as specified. The improvement may be most advantageous in heterogeneous and biphasic mixtures as well as high aspect ratio vessels (length to diameter ratio exceeding 2.0).

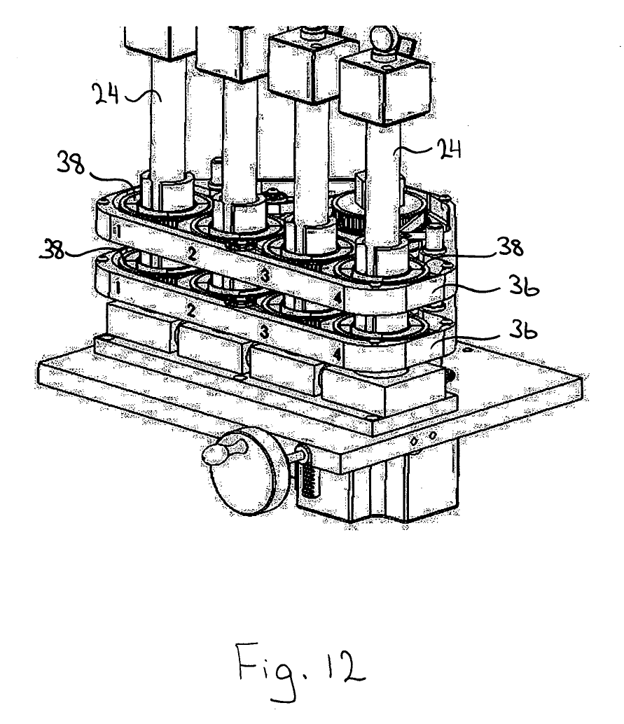

In another example embodiment, as shown in FIG. 12., the mixing efficiency for each module may be enhanced by including multiple internal/external magnet systems and mixer cases to be utilized on reactor(s) concurrently. One embodiment would have two or more mixer systems, spaced apart vertically as desired, operating in the same direction using the same motor drive. Therefore two internal magnets located at different vertical planes would be causing the vessel contents to mix accordingly. Another embodiment would be two or more mixer systems with opposite rotational directions. In this case, the internal magnets rotating in opposite directions may cause improved mixing efficiency due to impeller profiles and resulting fluid movements. Here again, the improvement may be most advantageous in heterogeneous and biphasic mixtures as well as high aspect ratio vessels (length to diameter ratio exceeding 2.0).

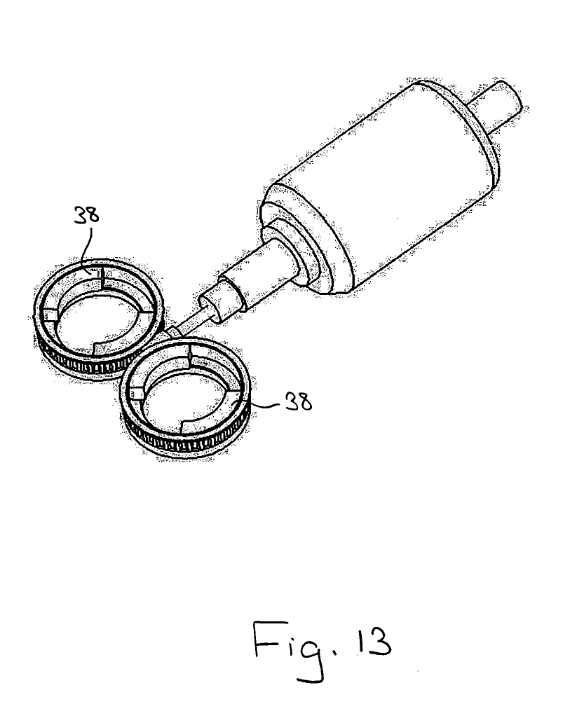

As yet another example, FIG. 13 provides an alternative drive mechanism for the rotating drive magnets other than the belt system described above. In particular, FIG. 13 shows each drive magnet being rotated by a motor with a worm gear connected to the drive shaft. Rotation of the motor causes the worm gear to rotate the drive magnets. Of course, any number of alternative drive arrangements and other alternative embodiments are possible without departing from the spirit and scope of the invention. Therefore, the spirit and scope of the invention should not be limited to the description of the preferred versions contained herein.

What is claimed is:

1. A laboratory mixing device comprising:
a. at least one reactor;
b. a wheel encompassing the at least one reactor such that the axis of the wheel is substantially coaxial with the at least one reactor;
c. at least one drive magnet positioned upon the wheel and rotatable, the at least one drive magnet comprising at least one permanent magnet and providing opposite magnetic poles upon the wheel; and
d. at least one mixer comprising a permanent magnet positioned within the at least one reactor, wherein a magnetic coupling between the at least one drive magnet and the mixer results in rotation of the mixer when the at least one drive magnet rotates.

2. The laboratory mixing device of claim 1 wherein the at least one reactor comprises a plurality of cylindrical reactors.

3. The laboratory mixing device of claim 2 further comprising a plurality of wheels, each of the plurality of wheels encompassing the plurality of cylindrical reactors and each of the plurality of wheels having at least one drive magnet positioned thereon.

4. The laboratory mixing device of claim 1 wherein the at least one drive magnet comprises two permanent magnets positioned upon the wheel.

5. The laboratory mixing device of claim 4 wherein the two permanent magnets are directly opposed upon the wheel.

6. The laboratory mixing device of claim 1 wherein the wheel is rotatable.

7. The laboratory mixing device of claim 6 wherein the wheel is rotated by a belt.

8. The laboratory mixing device of claim 7 wherein the belt is driven by a pulley.

9. The laboratory mixing device of claim 8 wherein the pulley is driven by a motor.

10. The laboratory mixing device of claim 6 wherein the wheel is driven by a gear operably engaged with the drive shaft of a motor.

11. The laboratory mixing device of claim 1 wherein the reactor defines a central axis and the wheel is adjustable with respect to the at least one reactor along the central axis.

12. The laboratory mixing device of claim 11 wherein the wheel is positioned upon a lift.

13. The laboratory mixing device of claim 12 wherein the lift is operable to be moved parallel to the central axis.

14. The laboratory mixing device of claim 13 wherein the lift is driven by a lift handle and gear mechanism.

15. The laboratory mixing device of claim 1 further comprising at least one reactor holder encompassing the at least one reactor such that the wheel encompasses the at least one reactor holder.

16. The laboratory mixing device of claim 15 wherein the at least one reactor holder partially encompasses the at least one reactor.

17. A method of mixing a solution in at least one reactor comprising:
a. providing a wheel encompassing the at least one reactor such that the axis of the wheel is substantially coaxial with the at least one reactor;
b. providing at least one drive magnet upon the wheel such that the drive magnet is rotatable with respect to the reactor;
c. providing at least one mixer comprising a magnet positioned within the at least one reactor; and
d. rotating the at least one drive magnet such that a magnetic coupling between the at least one drive magnet and the mixer results in rotation of the mixer within the at least one reactor.

18. The method of claim 17 wherein the at least one drive magnet comprises two permanent magnets positioned upon the wheel.

19. The method of claim 18 wherein the two permanent magnets are directly opposed upon the wheel.

20. The method of claim 17 wherein the step of rotating the at least one drive magnet comprises rotating the wheel.

21. The method of claim 20 wherein the step of rotating the wheel includes moving a belt to rotate the wheel.

22. The method of claim 21 wherein the step of moving the belt includes driving a pulley to move the belt.

23. The method of claim 22 wherein the step of driving the pulley includes driving a motor to drive the pulley.

24. The method of claim 20 wherein the step of rotating the wheel includes driving a gear that meshes with teeth on the wheel.

25. The method of claim 17 further comprising the step of moving the wheel with respect to the at least one reactor along a central axis.

26. The method of claim 25 wherein the wheel is positioned upon a lift.

27. The method of claim 26 further comprising the step of cranking a lift handle to operate the lift.

28. The method of claim 17 further comprising the step of providing a reactor holder that encompasses the reactor such that the wheel encompasses the at least one reactor holder.

29. A mixing apparatus comprising:
a. at least one reactor defining an axis;
b. at least one wheel encompassing the at least one reactor and arranged and disposed to rotate about the at least one reactor;
c. at least one magnet positioned upon the at least one wheel; and
d. a lift arranged and disposed to move the at least one wheel parallel to the axis of the at least one reactor.

30. The mixing apparatus of claim 29 wherein the at least one reactor comprises a plurality of reactors.

31. The mixing apparatus of claim 30 wherein the at least one wheel comprises a plurality of wheels.

32. The mixing apparatus of claim 30 wherein the at least one magnet includes a plurality of magnets.

33. The mixing apparatus of claim 29 further comprising at least one mixer disposed within the at least one reactor and in magnetic communication with the at least one magnet.

34. The mixing apparatus of claim 31 wherein the plurality of wheels are supported by a mixer case.

35. The mixing apparatus of claim 29 wherein the at least one wheel is driven by a pulley.

36. The mixing apparatus of claim 29 wherein the at least one wheel is driven by a gear.
